(19) United States
(12) Patent Application Publication
(10) Pub. No.: US 2012/0262620 A1
(43) Pub. Date: Oct. 18, 2012

(54) ELECTRONIC DEVICE AND CAMERA ADJUSTMENT METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/183,451

(22) Filed: Jul. 15, 2011

(30) Foreign Application Priority Data
Apr. 18, 2011 (TW) 100113441

(51) Int. Cl. H04N 5/225

(52) U.S. Cl. 348/333.08; 348/E05.024

(57) ABSTRACT

An electronic device includes an acceleration sensor, an electronic compass, a comparing unit, and a display. The comparing unit compares first displacement information and second displacement information of the electronic device with an initial displacement information of the electronic device, and determines a difference between the first displacement information, the second displacement information and the initial displacement information. Angle of the lens of a camera is adjusted according to the difference. The display is used to display an image captured by the lens of the camera.

BACKGROUND

1. Technical Field

The present disclosure relates to an electronic device and a camera adjustment method.

2. Description of Related Art

Cameras, such as pan-tilt-zoom (PTZ) cameras, and/or speed dome cameras, are commonly used in security systems. To adjust aim and/or focus of the cameras, appropriative control devices are needed by a user in a monitoring center. Once the user leaves the control devices, it is difficult to operate the cameras, and receive images captured by the lens of the cameras in a timely fashion. Therefore, there is room for improvement in the art.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a block diagram of an embodiment of an electronic device including a camera adjustment system.

FIGS. 2A, 2B, 2C, 2D, and 2E are schematic views showing the camera adjustment system of FIG. 1 adjusting a camera.

FIG. 3 is a flowchart of an embodiment of a camera adjustment method.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

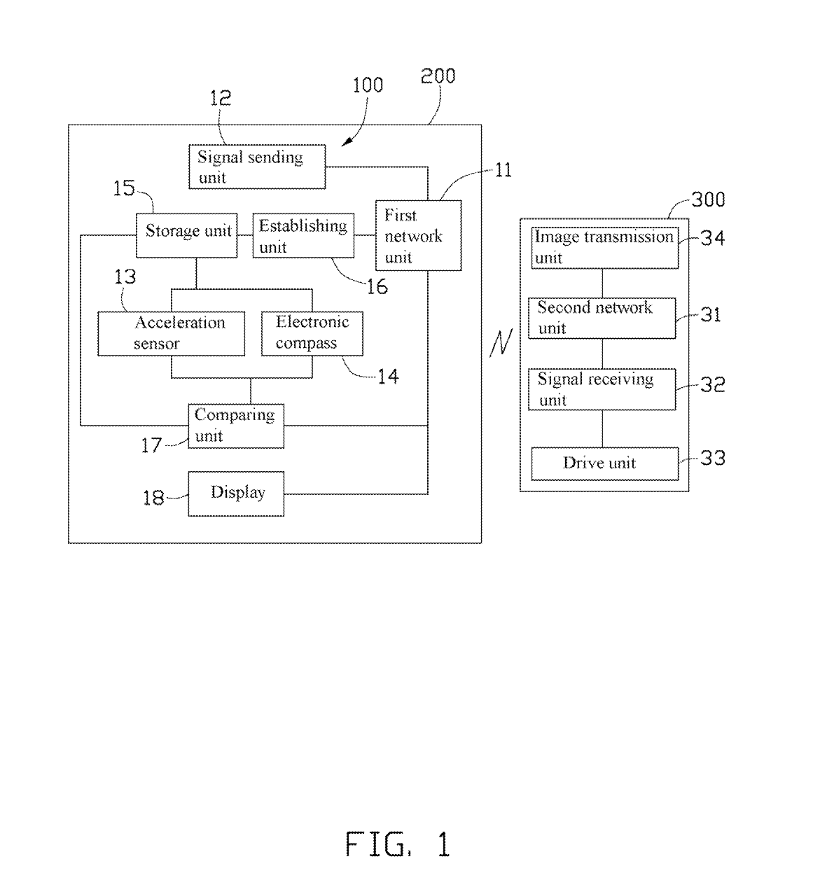

FIG. 1 is a block diagram of an embodiment of an electronic device 200 including a camera adjustment system 100. The camera adjustment system 100 is used to adjust an angle of the lens of a camera 300 according to the movements of the electronic device 200. The electronic device 200 can be a mobile phone, a personal digital assistant, or a notebook, as non-limiting examples. The camera 300 can be a rotating camera, a speed dome camera, or a pan-tilt-zoom camera.

The camera adjustment system 100 includes a first network unit 11, a signal sending unit 12, an acceleration sensor 13, an electronic compass 14, a storage unit 15, an establishing unit 16, a comparing unit 17, and a display 18.

The signal sending unit 12 is connected to the first network unit 11, and communicates with the camera 300 through the first network unit 11. When a user starts the camera adjustment system 100, the signal sending unit 12 sends a starting signal to the camera 300 through the first network unit 11, and controls the lens of the camera 300 to rotate to a predetermined reference position. The first network unit 11 can be a wired network, a wireless network, or a general packet radio service (GPRS).

The acceleration sensor 13 is electronically connected to the comparing unit 17, and is used to detect first displacement information of the electronic device 200, and send the first displacement information to the comparing unit 17. The first displacement information detected may coincide with and be interpreted as a user moves the electronic device 200 up and down.

The electronic compass 14 is electronically connected to the comparing unit 17, and is used to detect second displacement information of the electronic device 200, and send the second displacement information to the comparing unit 17. The second displacement information detected may coincide with and be interpreted as a user moves the electronic device 200 left and right.

The storage unit 15 may be a random access memory, or a read-only memory, for example. The storage unit 15 is connected to the acceleration sensor 13 and the electronic compass 14. The storage unit 15 stores initial displacement information of the electronic device 200. When a user starts the camera adjustment system 100, the acceleration sensor 13 and the electronic compass 14 detect the initial displacement information. The camera 300 can be a rotating camera, a speed dome camera, or a pan-tilt-zoom camera.

The establishing unit 16 is connected to the storage unit 15 and the first network unit 11, and communicates with the camera 300 through the first network unit 11. Thus, when the camera 300 is in the reference position, the establishing unit 16 obtains status information of the camera 300 through the first network unit 11, and establishes a corresponding relationship between the status information and the initial displacement information stored in the storage unit 15. Hence, the camera adjustment system 100 can adjust the lens angle of the camera 300 according to the relationship.

The comparing unit 17 is connected to the storage unit 15 and the first network unit 11. The comparing unit 17 is used to compare the first displacement information and the second displacement information detected by the acceleration sensor 13 and the electronic compass 14 with the initial displacement information stored in the storage unit 15, and then determines a difference between the first displacement information, the second displacement information, and the initial displacement information. The comparing unit 17 converts the difference into a corresponding control signal, and sends the control signal to the camera 300 through the first network unit 11.

The display 18 is connected to the first network unit 11, and is used to receive and display an image captured by the camera 300 via the first network unit 11.

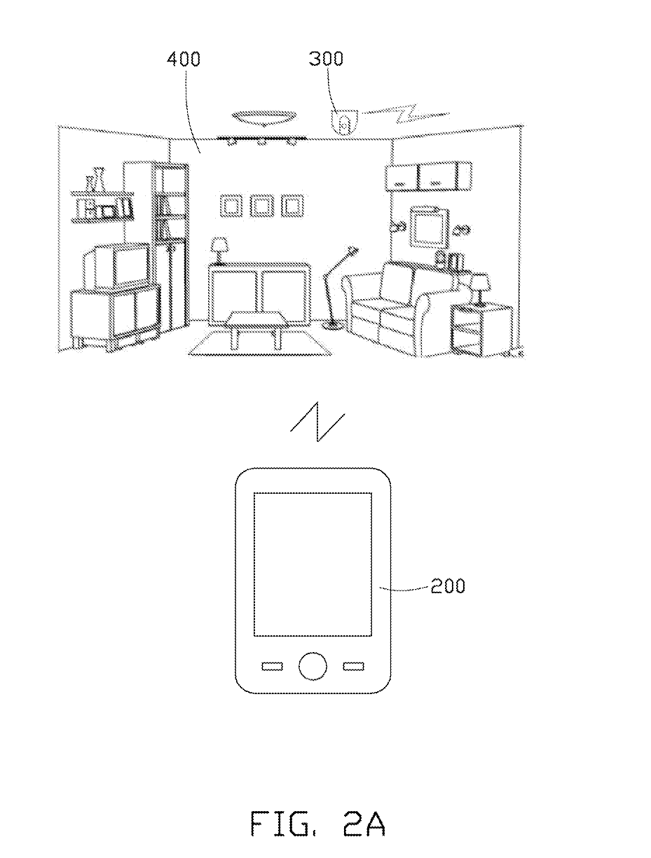

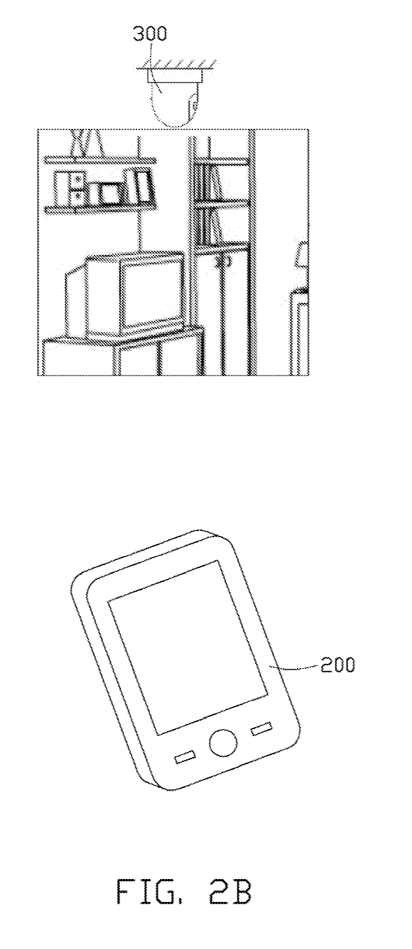

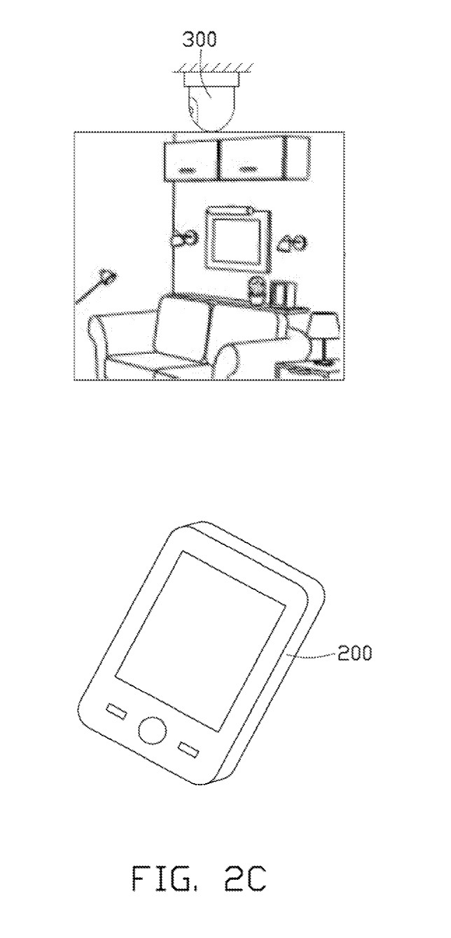

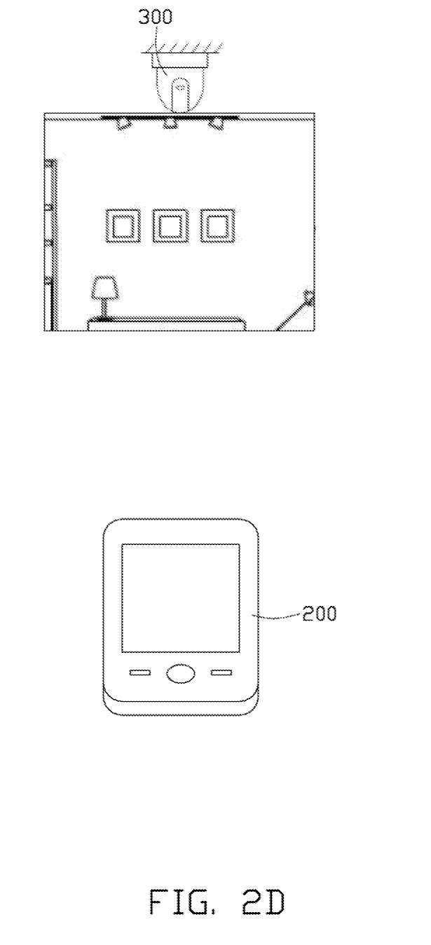

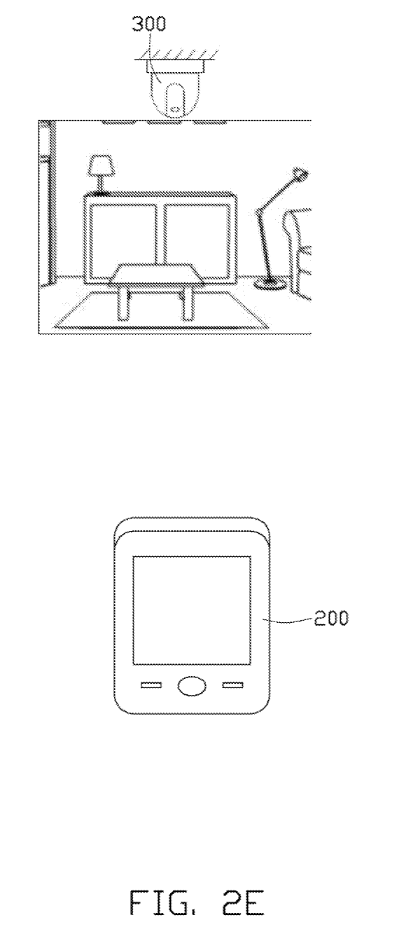

Referring to FIG. 2A, the camera 300 is used to monitor a location, such as a room 400. In one embodiment, the camera 300 is fixed on an appropriate position of a ceiling of the room 400. The camera 300 includes a second network unit 31, a signal receiving unit 32, a drive unit 33, and an image transmission unit 34. The image transmission unit 34, the second network unit 31, the signal receiving unit 32, and the drive unit 33 are connected in that order.

The signal receiving unit 32 communicates with the camera adjustment system 100 through the second network unit 31 and the first network unit 11. Thus, the signal receiving unit 32 can receive the starting signal from the signal sending unit 12 and the control signal from the comparing unit 17 through the second network unit 31, and send the starting signal and the control signal to the drive unit 33. The second network unit 31 can be a wired network, a wireless network, or a GPRS.

The drive unit 33 is used to receive the starting signal, and correspondingly control the camera 300 to the reference position according to the starting signal. The drive unit 33 also receives the control signal, and adjusts the angle of the lens of the camera 300 according to the control signal. For example, when the comparing unit 17 determines that the user moves the electronic device 200 up 45 degrees, it sends a corresponding control signal to the camera 300. The drive unit 33 receives the control signal, and controls the lens of camera 300 to move up 45 degrees.

The image transmission unit 34 is used to send an image captured by the lens of the camera 300 to the second network unit 31, and transmit to the display 18 by the second network unit 31.

Five non-limiting examples that explain the work process of the camera adjustment system 100 are given below.

Referring to FIG. 2A, when the user starts the camera adjustment system 100 via operating corresponding commands of the electronic device 200, the acceleration sensor 13 and the electronic compass 14 detect initial displacement information of the electronic device 200, and send the initial displacement information to the storage unit 15. Next, the signal sending unit 12 sends a corresponding starting signal to the camera 300 via the first network unit 11 for controlling the camera 300 to rotate to a predetermined reference position. When the camera 300 is in the reference position, the establishing unit 16 obtains status information of the camera 300 through the first network unit 11, and establishes a corresponding relationship between the status information and initial displacement information stored in the storage unit 15.

Referring to FIG. 2B, when the user moves the electronic device 200 left 45 degrees, the acceleration sensor 13 and the electronic compass 14 respectively detect the first displacement information and the second displacement information of the electronic device 200. Then, the comparing unit 17 compares the first displacement information and the second displacement information with the initial displacement information stored in the storage unit 15, and determines a difference between the first displacement information, the second displacement information, and the initial displacement information. The comparing unit 17 converts the difference into a corresponding control signal, and sends the control signal to the camera 300 through the first network unit 11. The drive unit 33 receives the control signal via the signal receiving unit 32, and controls the lens of camera 300 to move left 45 degrees. Finally, the image transmission unit 34 sends an image captured by the lens of the camera 300 to the second network unit 31, and to the display 18 via the second network unit 31.

Referring to FIG. 2C, when the user moves the electronic device 200 right 45 degrees, the acceleration sensor 13 and the electronic compass 14 respectively detect first displacement information and second displacement information of the electronic device 200. Then, the comparing unit 17 compares the first displacement information and the second displacement information with the initial displacement information stored in the storage unit 15, and determines a difference between the first displacement information, the second displacement information, and the initial displacement information. The comparing unit 17 converts the difference into a corresponding control signal, and sends the control signal to the camera 300 through the first network unit 11. The drive unit 33 receives the control signal via the signal receiving unit 32, and controls the lens of camera 300 to move right 45 degrees. Finally, the image transmission unit 34 sends an image captured by the lens of the camera 300 to the second network unit 31, and to the display 18 via the second network unit 31.

Referring to FIG. 2D, when the user moves the electronic device 200 up θ degrees, the acceleration sensor 13 and the electronic compass 14 respectively detect first displacement information and second displacement information of the electronic device 200. Then, the comparing unit 17 compares the first displacement information and the second displacement information detected with the initial displacement information stored in the storage unit 15, and determines a difference between the first displacement information, the second displacement information, and the initial displacement information. The comparing unit 17 converts the difference into a corresponding control signal, and sends the control signal to the camera 300 through the first network unit 11. The drive unit 33 receives the control signal via the signal receiving unit 32, and controls the lens of camera 300 to move up θ degrees. Finally, the image transmission unit 34 sends an image captured by the lens of the camera 300 to the second network unit 31, and to the display 18 via the second network unit 31.

Referring to FIG. 2E, when the user moves the electronic device 200 down θ degrees, the acceleration sensor 13 and the electronic compass 14 respectively detect first displacement information and second displacement information of the electronic device 200. Then, the comparing unit 17 compares the first displacement information and the second displacement information with the initial displacement information stored in the storage unit 15, and determines the difference between the first displacement information, the second displacement information, and the initial displacement information. The comparing unit 17 converts the difference into a corresponding control signal, and sends the control signal to the camera 300 through the first network unit 11. The drive unit 33 receives the control signal via the signal receiving unit 32, and controls the lens of camera 300 to move down θ degrees. Finally, the image transmission unit 34 sends an image captured by the lens of the camera 300 to the second network unit 31, and to the display 18 via the second network unit 31.

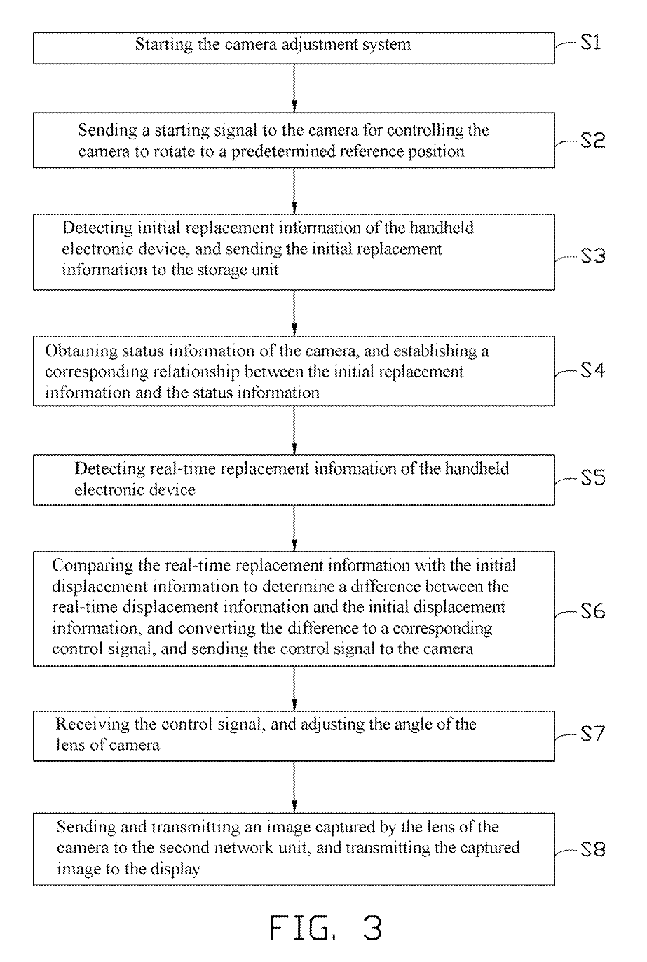

Referring to FIG. 3, an embodiment of a camera adjustment method includes the following steps.

In step 1, the user starts the camera adjustment system 100.

In step 2, the signal sending unit 12 sends a starting signal to the camera 300 for controlling the camera 300 to rotate to a predetermined reference position.

In step 3, the acceleration sensor 13 and the electronic compass 14 detect initial replacement information of the electronic device 200 when starting the camera adjustment system 100, and send the initial replacement information to the storage unit 15.

In step 4, the establishing unit 16 obtains status information of the camera 300 which is in the reference position, and establishes a corresponding relationship between the initial replacement information and the status information.

In step 5, the acceleration sensor 13 and the electronic compass 14 detect real-time replacement information (e.g., the first replacement information and the second replacement information) of the electronic device 200, such as moving the electronic device 200 up 45 degrees.

In step 6, the comparing unit 17 compares the real-time replacement information with the initial displacement information stored in the storage unit 15, and determines a difference between the real-time displacement information and the initial displacement information. The comparing unit 17 converts the difference to a corresponding control signal, and sends the control signal to the camera 300 through the first network unit 11.

In step 7, the drive unit 33 receives the control signal via the signal receiving unit 32, and adjusts the angle of the lens of camera 300. For example, moves the lens of the camera 300 left 45 degrees according to the control signal.

In step 8, the image transmission unit 34 sends an image captured by the lens of the camera 300 to the second network unit 31, and to the display 18 via the second network unit 31.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. An electronic device for adjusting an angle of the lens of a camera comprising a lens, the electronic device comprising:
an acceleration sensor that detects first displacement information of the electronic device;
an electronic compass that detects second displacement information of the electronic device;
a comparing unit connected to the acceleration sensor and the electronic compass, wherein the comparing unit compares the first displacement information and the second displacement information with an initial displacement information of the electronic device, and determines a difference between the first displacement information, the second displacement information and the initial displacement information, and adjusts angle of the lens of the camera according to the difference; and
a display used to display an image captured by the lens of the camera.

2. The electronic device of claim 1, further including a storage unit to store the initial displacement information.

3. The electronic device of claim 1, further including a signal sending unit and a first network unit, the signal sending unit connected to the first network unit, the signal sending unit sending a starting signal to the camera via the first network unit, and controlling the lens of the camera to rotate to a predetermined reference position.

4. The electronic device of claim 3, wherein the first network unit is a wireless network, a wired network or a GPRS.

5. The electronic device of claim 3, further including an establishing unit connected to the storage unit and the first network unit, wherein the establishing unit obtains status information of the camera which is in the reference position, and establishes a relationship between the status information and the initial information.

6. The electronic device of claim 3, wherein the camera including a second network unit, a signal receiving unit, and a drive unit, the second network unit, the signal receiving unit and the drive unit are connected in that order, the signal receiving unit receiving the controlling signal, and transmitting the control signal to the drive unit, the drive unit used to receive the control signal, and adjust the angle of the lens of the camera.

7. The electronic device of claim 6, wherein the signal receiving unit receives the starting signal and sends the starting signal to the drive unit, the drive unit receiving the starting signal, and adjusting the lens of the camera rotate to the reference position.

8. The electronic device of claim 6, wherein the camera including an image transmission unit used to send an image captured by the lens of the camera to the display by the second network unit.

9. A camera adjustment method for adjusting an angle of lens of a camera using an electronic device, the method comprising:
detecting real-time displacement information of the electronic device;
comparing the real-time displacement information with an initial displacement information of the electronic device, and determining a difference between the real-time displacement and the initial displacement information;
adjusting the angle of the lens of the camera according to the difference; and
displaying an image captured by the lens of the camera.

10. The method of claim 9, further including the following steps before the step of detecting real-time displacement information of the electronic device:
detecting the initial displacement information of the electronic device, and storing the initial displacement information;
obtaining status information of the camera, and establishing a relationship between the initial displacement information and the status information.

11. The method of claim 9, wherein the first displacement information of the electronic device is detected when moving the electronic device up and down, the second displacement information of the electronic device is detected when moving the electronic device left and right, and the first displacement information and second displacement information form the real-time displacement information.
